(19) United States
(12) Patent Application Publication
(10) Pub. No.: US 2026/0149046 A1
(43) Pub. Date: May 28, 2026

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Hong Ryeol PARK, Suwon-si (KR); Hyun Bong CHOI, Suwon-si (KR); Sang Woo PARK, Suwon-si (KR); So Hee KIM, Suwon-si (KR); Woo Jung JI, Suwon-si (KR); Da Sol JUN, Suwon-si (KR); Young Kyeong SHIN, Suwon-si (KR)

(73) Assignee: SAMSUNG SDI CO., LTD., Yongin-si (KR)

(21) Appl. No.: 19/400,030

(22) Filed: Nov. 25, 2025

(30) Foreign Application Priority Data
Nov. 26, 2024 (KR) 10-2024-0171044

(51) Int. Cl. H01M 10/0567; H01M 10/052; H01M 10/0569; H01M 50/103; H01M 50/105; H01M 50/107

(52) U.S. Cl. CPC H01M 10/0567; H01M 10/052; H01M 10/0569; H01M 50/103; H01M 50/105; H01M 50/107; H01M 2300/004

(57) ABSTRACT

Provided are an electrolyte for a rechargeable lithium battery, and a rechargeable lithium battery including the electrolyte. The electrolyte includes a non-aqueous organic solvent, a lithium salt, and an additive. The additive includes a mixture of a first additive and a second additive, and the weight ratio of the first additive to the second additive is in a range of about 1:10 to about 1:150.

### CROSS-REFERENCE TO RELATED APPLICATION

The present application claims priority to Korean Patent Application No. 10-2024-0171044, filed on Nov. 26, 2024 in the Korean Intellectual Property Office, the entire disclosure of which is incorporated herein by reference.

### BACKGROUND

### 1. Field of the Disclosure

The present disclosure relates to an electrolyte for a rechargeable lithium battery, and a rechargeable lithium battery including the electrolyte.

### 2. Discussion of Related Art

With increasing presence of electronic devices using batteries such as, e.g., mobile phones, laptop computers, electric vehicles, and the like, the demand for rechargeable batteries with high energy density and high capacity has increased. Accordingly, improving the performance of rechargeable lithium batteries may be advantageous.

A rechargeable lithium battery includes positive and negative electrodes that include active materials capable of intercalation and deintercalation of lithium ions, and an electrolyte, and the rechargeable lithium battery produces electrical energy through oxidation and reduction reactions when the lithium ions are intercalated/deintercalated into/from the positive and negative electrodes.

As the electrolyte of such rechargeable lithium batteries, an electrolyte in which a lithium salt dissolves in a non-aqueous organic solvent is used. Rechargeable lithium batteries exhibit battery characteristics through complex reactions between the positive electrode and the electrolyte, between the negative electrode and the electrolyte, and the like. Therefore, the use of a desired electrolyte is a relevant parameter in improving the performance of rechargeable lithium batteries.

### SUMMARY

The present disclosure describes an electrolyte for a rechargeable lithium battery, which improves lifetime and storability over a wide temperature range including low, room and high temperatures, and improves high-rate performance in a rechargeable lithium battery.

The present disclosure also describes a rechargeable lithium battery, which includes the electrolyte.

One example embodiment includes an electrolyte for a rechargeable lithium battery, which includes a non-aqueous organic solvent, a lithium salt, and an additive. The additive includes a mixture of a first additive represented by Chemical Formula 1 below and a second additive represented by Chemical Formula 2 below, and the weight ratio of the first additive to the second additive is in a range of about 1:10 to about 1:150:

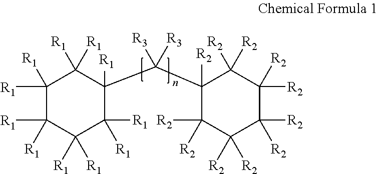

In Chemical Formula 1,
R₁ is the same or different, and each independently is or includes hydrogen, a halogen, a C1 to C10 alkyl group, or an isocyanate group; and at least one R₁ is an isocyanate group,
R₂ is the same or different, and each independently is or includes hydrogen, a halogen, a C1 to C10 alkyl group, or an isocyanate group; and at least one R₂ is an isocyanate group,
R₃ is the same or different, and each independently is or includes hydrogen, or a cyclohexyl isocyanate residue, and
n is an integer in a range from 1 to 10.

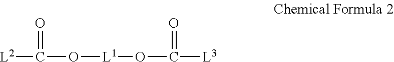

In Chemical Formula 2,
L¹ is or includes a substituted or unsubstituted C1 to C10 alkylene group, and
L² and L³ each independently is or includes a substituted or unsubstituted C1 to C3 alkyl group.

Another example embodiment includes a rechargeable lithium battery, which includes a positive electrode containing a positive electrode active material, a negative electrode containing a negative electrode active material, and the above-discussed electrolyte.

The electrolyte according to one example embodiment can provide a rechargeable lithium battery, which improves lifetime and storability over a wide temperature range including low, room and high temperatures, and improves high-rate performance.

### BRIEF DESCRIPTION OF THE DRAWINGS

FIG. 1 is a conceptual diagram schematically showing a rechargeable lithium battery according to one example embodiment of the present disclosure.

FIG. 2 to FIG. 5 are cross-sectional views schematically showing rechargeable lithium batteries according to example embodiments.

### DETAILED DESCRIPTION

In order to fully understand the configurations and effects of the present disclosure, example embodiments of the present disclosure are described with reference to the accompanying drawings. However, it should be understood that the example embodiments disclosed below may be embodied in various forms and modified in various ways without being limited to the example embodiments described herein. However, the description of the example embodiments is provided only to ensure that the disclosure of the present disclosure is made complete, and to fully inform a person having ordinary skill in the art to which the present disclosure belongs of the scope of the present disclosure.

In the present specification, when any component is referred to as being “on” another component, it means that the component may be formed directly on the other component, or a third component may be interposed therebetween. Also, in the drawings, the thicknesses of components may be exaggerated for the effective description of the technical contents.

Throughout the present specification, parts denoted by the same reference numerals denote the same components.

Unless otherwise specified in the present specification, anything indicated in the singular may also include the plural. In addition, unless otherwise particularly stated herein, “A or B” may mean “including A, including B, or including A and B.” As used in the present specification, the term “comprise” and/or “comprising” do not exclude the presence or addition of one or more other components.

In the present specification, the term “combination thereof” may refer to a mixture, laminate, composite, copolymer, alloy, blend, reaction product, and the like of components.

Unless otherwise defined in the present specification, the term “substituted” means that at least one hydrogen in a substituent or compound is replaced with deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, or a combination thereof.

For example, the term “substituted” may mean that at least one hydrogen in a substituent or compound is replaced with deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the term “substituted” may mean that at least one hydrogen in a substituent or compound is replaced with deuterium, a halogen group, a C1 to C20 alkyl group, a C6 to C30 aryl group, a C1 to C10 fluoroalkyl group, or a cyano group. Alternatively, the term “substituted” may mean that at least one hydrogen in the substituent or compound is replaced with deuterium, a halogen group, a C1 to C5 alkyl group, a C6 to C18 aryl group, a C1 to C5 fluoroalkyl group, or a cyano group. As an example, the term “substituted” may mean that at least one hydrogen in the substituent or compound is replaced with deuterium, a cyano group, a halogen group, a methyl group, an ethyl group, a propyl group, a butyl group, a phenyl group, a biphenyl group, a terphenyl group, a trifluoromethyl group, or a naphthyl group.

Unless otherwise particularly defined in the present specification, the symbol “*” refers to a moiety that is connected to the same or different atom or chemical formula. Unless specifically mentioned in the chemical formulas described in the present specification, it may be seen that hydrogen is bonded in the structure of the chemical formula.

When the terms “about” or “substantially” are used in this specification in connection with a numerical value, it is intended that the associated numerical value include a tolerance of +10% around the stated numerical value. When ranges are specified, the range includes all values therebetween such as increments of 0.1%.

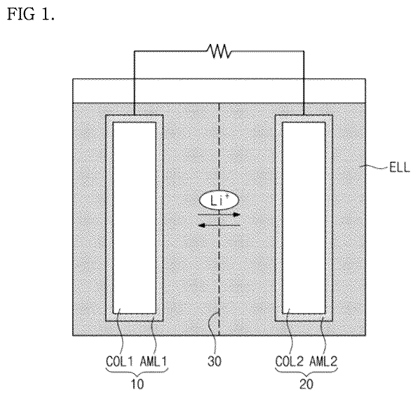

FIG. 1 is a conceptual diagram schematically showing a rechargeable lithium battery according to one example embodiment of the present disclosure. Referring to FIG. 1, the rechargeable lithium battery may include a positive electrode 10, a negative electrode 20, a separator 30, and an electrolyte (ELL).

The positive electrode 10 and the negative electrode 20 may be spaced apart from each other with the separator 30 interposed therebetween. The separator 30 may be disposed between the positive electrode 10 and the negative electrode 20. The positive electrode 10, the negative electrode 20 and the separator 30 may be in contact with the electrolyte (ELL). The positive electrode 10, the negative electrode 20 and the separator 30 may be impregnated with the electrolyte (ELL).

The electrolyte (ELL) may be or include a medium for transferring lithium ions between the positive electrode 10 and the negative electrode 20. In the electrolyte (ELL), the lithium ions may pass through the separator 30 to move toward the positive electrode 10 or the negative electrode 20.

### Positive Electrode 10

A positive electrode 10 for a rechargeable lithium battery may include a current collector (COL1), and a positive electrode active material layer (AML1) formed on the current collector (COL1). The positive electrode active material layer (AML1) includes a positive electrode active material and may further include a binder and/or a conductive material.

As an example, the positive electrode 10 may further include an additive that may constitute a sacrificial positive electrode.

The content of the positive electrode active material in the positive electrode active material layer (AML1) may range from about 90% by weight to about 99.5% by weight based on 100% by weight of the positive electrode active material layer (AML1). The contents of the binder and conductive material may each range from about 0.5% by weight to about 5% by weight based on 100% by weight of the positive electrode active material layer (AML1).

The binder adheres positive electrode active material particles to each other, and also adheres the positive electrode active material to the current collector (COL1). Representative examples of the binder include at least one of polyvinyl alcohol, carboxymethyl cellulose, hydroxypropyl cellulose, diacetyl cellulose, polyvinyl chloride, carboxylated polyvinyl chloride, polyvinyl fluoride, a polymer containing ethylene oxide, polyvinyl pyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, but the present disclosure is not limited thereto.

The conductive material may impart conductivity to the electrodes, and any material may be used as long as the material is electronically conductive without causing adverse chemical changes in the battery to be formed. Examples of the conductive material include carbon-based materials such as at least one of natural graphite, artificial graphite, carbon black, acetylene black, Ketjen black, carbon fibers, carbon nanofibers, carbon nanotubes, and the like; metal-based materials in the form of metal powder or metal fibers containing at least one of copper, nickel, aluminum, silver, and the like; conductive polymers such as polyphenylene derivatives and the like; or a mixture thereof.

Al may be used as the current collector (COL1), but the present disclosure is not limited thereto.

### Positive Electrode Active Material

As the positive electrode active material in the positive electrode active material layer (AML1), a compound capable of reversible intercalation and deintercalation of lithium (lithiated intercalation compound) may be used. For example, at least one of a composite oxide of lithium and a metal such as or including at least one of cobalt, manganese, nickel, and a combination thereof, may be used.

The composite oxide may be or include a lithium transition metal composite oxide, and examples thereof include at least one of a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following chemical formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0 b≤0.5, 0≤c≤0.5, 0<α<2); LiₐNi_{b}Co_{c}L¹_{d}GₑO₂ (0.90≤a≤1.8, 0≤b≤0.9, 0≤c 0.5, 0≤d≤0.5, 0≤e≤0.1); LiₐNiGbO₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A is or includes at least one of Ni, Co, Mn, or a combination thereof, X is or includes at least one of Al, Ni, Co, Mn, Cr, Fe, Mg, Sr, V, a rare earth element, or a combination thereof, D is or includes at least one of O, F, S, P, or a combination thereof, G is or includes at least one of Al, Cr, Mn, Fe, Mg, La, Ce, Sr, V, or a combination thereof, and L¹ is or includes at least one of Mn, Al, or a combination thereof.

As an example, the positive electrode active material may be or include a high-nickel positive electrode active material in which the content of nickel is about 80 mol % or more, about 85 mol % or more, about 90 mol % or more, about 91 mol % or more, or about 94 mol % or more, and about 99 mol % or less, based on 100 mol % of metals excluding lithium in the lithium transition metal composite oxide. The high-nickel positive electrode active material may achieve high capacity, and thus may be applied to high-capacity, high-density rechargeable lithium batteries.

### Negative Electrode 20

A negative electrode 20 for a rechargeable lithium battery includes a current collector (COL2) and a negative electrode active material layer (AML2) disposed on the current collector (COL2). The negative electrode active material layer (AML2) includes a negative electrode active material, and may further include a binder and/or a conductive material.

For example, the negative electrode active material layer (AML2) may include about 90% by weight to about 99% by weight of the negative electrode active material, about 0.5% by weight to about 5% by weight of the binder, and about 0% by weight to about 5% by weight of the conductive material.

The binder adheres negative electrode active material particles to each other, and also adheres the negative electrode active material to the current collector (COL2). Anon-aqueous binder, an aqueous binder, a dry binder, or a combination thereof may be used as the binder.

The non-aqueous binder includes at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be or include at least one of styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinyl pyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenol resin, an epoxy resin, polyvinyl alcohol, and a combination thereof.

When the aqueous binder is used as the negative electrode binder, the aqueous binder may further include a cellulose-based compound capable of imparting viscosity. As the cellulose-based compound, at least one or more types of carboxymethyl cellulose, hydroxypropylmethyl cellulose, methyl cellulose, or alkali metal salts thereof may be mixed and used. At least one of Na, K or Li may be used as the alkali metal.

The dry binder is or includes a fiberizable polymeric material, and may be or include, for example, at least one of polytetrafluoroethylene, polyvinylidene fluoride, a polyvinylidene fluoride-hexafluoropropylene copolymer, polyethylene oxide, or a combination thereof.

The conductive material may impart conductivity to the electrodes, and any material may be used as long as the material is electronically conductive without causing adverse chemical changes in the battery to be formed. Examples include carbon-based materials such as at least one of natural graphite, artificial graphite, carbon black, acetylene black, Ketjen black, carbon fibers, carbon nanofibers, carbon nanotubes, and the like; metal-based materials in the form of metal powder or metal fibers containing at least one of copper, nickel, aluminum, silver, and the like; conductive polymers such as polyphenylene derivatives and the like; or a mixture thereof.

A current collector including at least one of copper foil, nickel foil, stainless steel foil, titanium foil, a nickel foam, a copper foam, a polymer substrate coated with a conductive metal, and a combination thereof, may be used as the current collector (COL2).

### Negative Electrode Active Material

The negative electrode active material in the negative electrode active material layer (AML2) includes at least one of a material capable of reversible intercalation/deintercalation of lithium ions, a lithium metal, an alloy of lithium and a metal, a material capable of doping and dedoping lithium, or a transition metal oxide.

The material capable of reversible intercalation/deintercalation of lithium ions may include a carbon-based negative electrode active material, for example, crystalline carbon, amorphous carbon, or a combination thereof. Examples of the crystalline carbon include graphite such as amorphous, plate-like, flaky, spherical, or fibrous natural or artificial graphite. Examples of the amorphous carbon include at least one of soft carbon or hard carbon, mesophase pitch carbide, calcined coke, and the like.

As the alloy of lithium and a metal, an alloy of lithium and a metal such as or including at least one of Na, K, Rb, Cs, Fr, Be, Mg, Ca, Sr, Si, Sb, Pb, In, Zn, Ba, Ra, Ge, Al, and Sn may be used.

As the material capable of doping and dedoping lithium, a Si-based negative electrode active material or a Sn-based negative electrode active material may be used. The Si-based negative electrode active material may be or include at least one of silicon, a silicon-carbon composite, SiOₓ (0<x<2), a Si-Q alloy (wherein Q is or includes at least one of an alkali metal, an alkaline earth metal, a Group 13 element, a Group 14 element (excluding Si), a Group element, a Group 16 element, a transition metal, a rare earth element, and a combination thereof), or a combination thereof. The Sn-based negative electrode active material may be or include at least one of Sn, SnO₂, a Sn-based alloy, or a combination thereof.

The silicon-carbon composite may be or include a composite of silicon and amorphous carbon. According to one example embodiment, the silicon-carbon composite may be in the form of silicon particles which surfaces are coated with amorphous carbon. For example, the silicon-carbon composite may include a secondary particle (core) in which silicon primary particles are assembled, and an amorphous carbon coating layer (shell) disposed on the surface of the secondary particle. The amorphous carbon may also be located between the silicon primary particles, and for example, the silicon primary particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer disposed on the surface of the core.

The Si-based negative electrode active material or the Sn-based negative electrode active material may be used in combination with a carbon-based negative electrode active material.

### Separator 30

A separator 30 may be present between the positive electrode 10 and the negative electrode 20 depending on the type of rechargeable lithium battery. As the separator 30, at least one of polyethylene, polypropylene, polyvinylidene fluoride, or a multi-layer film of two or more layers thereof, may be used. For example, a mixed multi-layer film such as or including at least one of a polyethylene/polypropylene two-layer separator, a polyethylene/polypropylene/polyethylene three-layer separator, a polypropylene/polyethylene/polypropylene three-layer separator, and the like, may also be used.

The separator 30 may include a porous substrate and a coating layer including an organic material, an inorganic material, or a combination thereof and disposed on one surface, or on both surfaces, of the porous substrate.

The porous substrate may be or include a polymer film formed of or including any one polymer such as at least one of polyolefins such as polyethylene, polypropylene, and the like, polyesters such as at least one of polyethylene terephthalate, polybutylene terephthalate, polyethylene naphthalate and the like, polyacetal, polyamide, polyimide, polycarbonate, polyether ketone, polyarylether ketone, polyetherimide, polyamideimide, polybenzimidazole, polyether sulfone, polyphenylene oxide, a cyclic olefin copolymer, polyphenylene sulfide, glass fibers, Teflon, and polytetrafluoroethylene, or a copolymer or mixture of two or more thereof.

The organic material may include a polyvinylidene fluoride-based polymer or a (meth)acrylic polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but the present disclosure is not limited thereto.

The organic and inorganic materials may be present as a mixture in one coating layer, or may be present in a form in which a coating layer including an organic material and a coating layer including an inorganic material are laminated.

### Electrolyte (ELL)

An electrolyte (ELL) for a rechargeable lithium battery includes a non-aqueous organic solvent and a lithium salt.

The non-aqueous organic solvent constitutes a medium through which ions involved in the electrochemical reaction of the battery may move.

The non-aqueous organic solvent may be or include at least one of a carbonate-based, ester-based, ether-based, ketone-based, or alcohol-based solvent, an aprotic solvent, or a combination thereof.

As the carbonate-based solvent, at least one of dimethyl carbonate (DMC), diethyl carbonate (DEC), dipropyl carbonate (DPC), methyl propyl carbonate (MPC), ethyl propyl carbonate (EPC), ethyl methyl carbonate (EMC), ethylene carbonate (EC), propylene carbonate (PC), butylene carbonate (BC), and the like may be used.

As the ester-based solvent, at least one of methyl acetate, ethyl acetate, n-propyl acetate, dimethyl acetate, methyl propionate, ethyl propionate, decanolide, mevalonolactone, valerolactone, caprolactone, and the like may be used.

As the ether-based solvent, at least one of dibutyl ether, tetraglyme, diglyme, dimethoxyethane, 2-methyltetrahydrofuran, 2,5-dimethyltetrahydrofuran, tetrahydrofuran, and the like may be used. Also, cyclohexanone and the like may be used as the ketone-based solvent. Ethyl alcohol, isopropyl alcohol, and the like, may be used as the alcohol-based solvent. At least one of nitriles such as R—CN (where R is a linear, branched, or cyclic hydrocarbon group having 2 to 20 carbon atoms and may include a double bond, an aromatic ring, or an ether group) and the like; amides such as dimethylformamide and the like; dioxolanes such as 1,3-dioxolane, 1,4-dioxolane, and the like; and sulfolanes, may be used as the aprotic solvent.

The non-aqueous organic solvents may be used alone, or in combination of two or more solvents.

For example, when the carbonate-based solvent is used, a cyclic carbonate and a chain carbonate may be used in combination, and the cyclic carbonate and the chain carbonate may be mixed in a volume ratio in a range of about 1:1 to about 1:9.

The lithium salt is or includes a material that dissolves in an organic solvent, and thus constitutes a source of lithium ions in the battery, thereby allowing the basic operation of a rechargeable lithium battery, and promotes the movement of lithium ions between the positive and negative electrodes. Representative examples of the lithium salt may include at least one or more of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide (LiFSI), LiC₄F₉SO₃, LiN(CₓF₂ₓ₊₁SO₂)(C_{y}F_{2y+1}SO₂) (where x and y are integers in a range from 1 to 20), lithium trifluoromethane sulfonate, lithium tetrafluoroethanesulfonate, lithium difluorobis(oxalato)borate (LiDFOB), lithium difluorobis(oxalato)phosphate (LiDFOP), and lithium bis(oxalato) borate (LiBOB).

### Rechargeable Lithium Battery

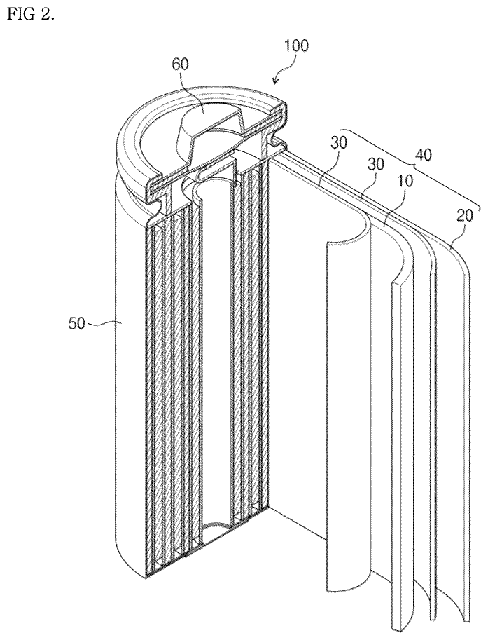

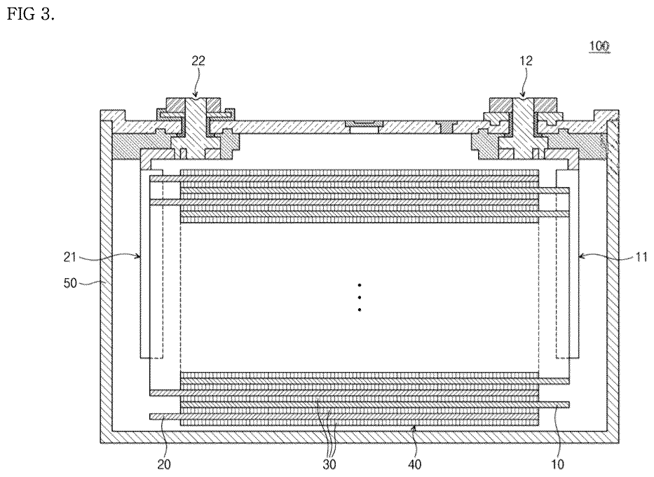

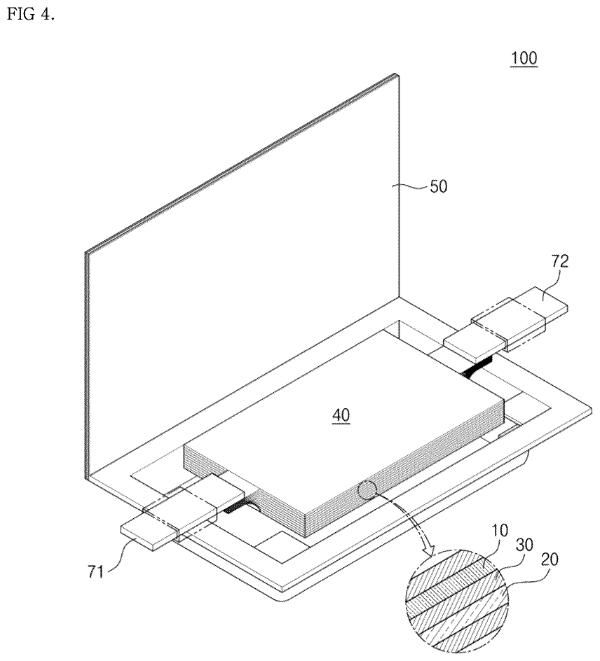

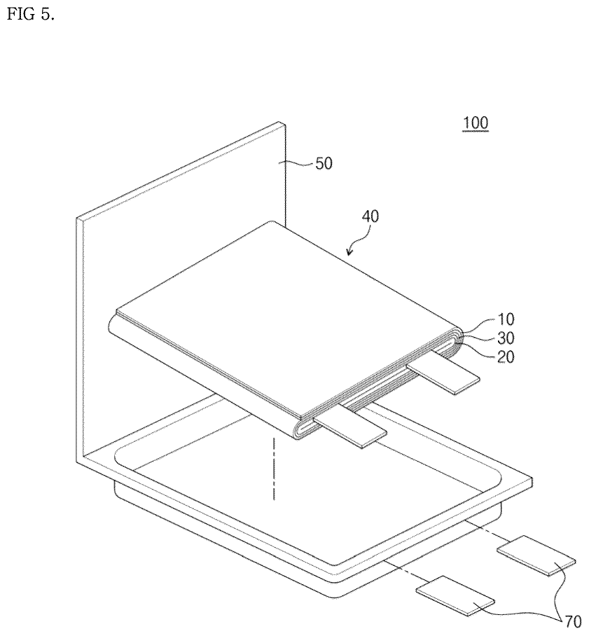

Rechargeable lithium batteries may be classified into cylindrical, prismatic, pouch-type, and coin-type rechargeable lithium batteries depending on the type of rechargeable lithium battery. FIG. 2 to FIG. 5 are diagrams schematically showing rechargeable lithium batteries according to example embodiments. The rechargeable lithium batteries can be said to be cylindrical, prismatic, and pouch-type batteries, as shown in FIG. 2, FIG. 3, and FIG. 4 and FIG. 5, respectively. Referring to FIG. 2 to FIG. 4, a rechargeable lithium battery 100 may include an electrode assembly 40 having a separator 30 interposed between a positive electrode and a negative electrode 20, and a case 50 in which the electrode assembly 40 is built. The positive electrode 10, the negative electrode 20, and the separator 30 may be impregnated with an electrolyte (not shown). The rechargeable lithium battery 100 may include a sealing member 60 configured to seal the case 50, as shown in FIG. 2. As shown in FIG. 3, the rechargeable lithium battery 100 may include a positive electrode lead tab 11, a positive electrode terminal 12 connected to the positive electrode lead tab 11, a negative electrode lead tab 21, and a negative electrode terminal 22 connected to the negative electrode lead tab 21. As shown in FIG. 4 and FIG. 5, the rechargeable lithium battery 100 may include the electrode tabs 70 illustrated in FIG. 5, or a positive electrode tab 71 and a negative electrode tab 72 illustrated in FIG. 4, the electrode tabs 70/71/72 forming electric paths configured to conduct current formed in the electrode assembly 40 to the outside of the battery 100.

Hereinafter, electrolytes for a rechargeable lithium battery according to example embodiments of the present disclosure are be described in further detail.

An electrolyte for a rechargeable lithium battery according to one example embodiment includes the above-described non-aqueous organic solvent, a lithium salt, and an additive, wherein the additive includes a mixture of a first additive represented by Chemical Formula 1 to be described below; and a second additive represented by Chemical Formula 2 to be described below. The weight ratio of the first additive to the second additive is in a range of about 1:10 to about 1:150.

The electrolyte may be prepared by a mixing process including dissolving a lithium salt in a non-aqueous organic solvent, mixing a first additive and a second additive in the above weight ratio, and adding the resulting mixture. Mixing processes for preparing an electrolyte are known in the field of electrolyte preparation, and any one process may be suitably selected by those of ordinary skill in the art and used.

The non-aqueous organic solvent according to one example embodiment of the present disclosure may include one or more types of non-aqueous organic solvents which have been described above.

In one example embodiment, the non-aqueous organic solvent may be or include a mixture including ethylene carbonate (EC), ethyl methyl carbonate (EMC), and dimethyl carbonate (DMC) in a volume ratio of about 10 to 30:20 to 50:20 to 50. Here, the volume ratio is a value based on 100 vol % of the total of ethylene carbonate (EC), ethyl methyl carbonate (EMC), and dimethyl carbonate (DMC). Within the above range, it can be possible to realize the effect of the additive mixture to be described below, and the lifetime of a battery can be improved due to a low reduction and decomposition rate of a positive electrode in a rechargeable lithium battery.

The lithium salt according to one example embodiment of the present disclosure may include at least one or more of LiPF₆, LiClO₄, LiBF₄, lithium bis(fluorosulfonyl)imide (LiFSI), lithium bis(trifluoromethanesulfonyl)imide (LiTFSI), LiSO₃CF₃, LiBOB, LiDFOB, LiDFBOP, LiTFOP, LiPO₂F₂, LiSbF₆, LiAsF₆, LiAlO₂, LiAlCl₄, LiCl, LiI, LiN(SO₃C₂F₅)₂, Li(FSO₂)₂N, and LiC₄F₉SO₃. According to one example embodiment, LiPF₆ may be used as the lithium salt.

The concentration of the lithium salt may be in a range of about 0.1M to about 3.0M. For example, the concentration of the lithium salt may be about 0.5M or more, or 1.0M or more. The concentration of the lithium salt may be about 3.0M or less, 2.5M or less, or 2.0M or less. In the present disclosure, when the concentration of the lithium salt is in a range of about 0.1M to about 2.0M, the conductivity of the electrolyte and the viscosity of the electrolyte may be maintained as desired.

### Additive

An additive according to one example embodiment of the present disclosure includes a first additive and a second additive, which are described below.

### First Additive

A first additive according to one example embodiment of the present disclosure is represented by Chemical Formula 1 below.

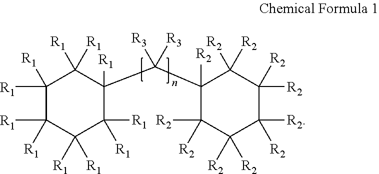

In Chemical Formula 1,
R₁ is the same or different, and may each independently be or include hydrogen, a halogen, a C₁ to C₁₀ alkyl group, or an isocyanate group. At least one R₁ may be or include an isocyanate group.
R₂ is the same or different, and may each independently be or include hydrogen, a halogen, a C₁ to C₁₀ alkyl group, or an isocyanate group. At least one R₂ is or includes an isocyanate group.
R₃ is the same or different, and may each independently be or include hydrogen, or a cyclohexyl isocyanate residue.
n may be an integer in a range from 1 to 10.

An additive according to another example embodiment of the present disclosure may be represented by Chemical Formula 1-1 below.

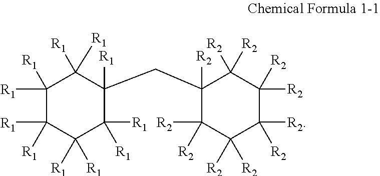

In Chemical Formula 1-1,
R₁ is the same or different, and may each independently be or include hydrogen, a halogen, a C₁ to C₁₀ alkyl group, or an isocyanate group. At least one R₁ may be or include an isocyanate group.
R₂ is the same or different, and may each independently be or include hydrogen, a halogen, a C₁ to C₁₀ alkyl group, or an isocyanate group. At least one R₂ may be or include an isocyanate group.

The first additive according to another example embodiment of the present disclosure may be represented by Chemical Formula 1-2 below.

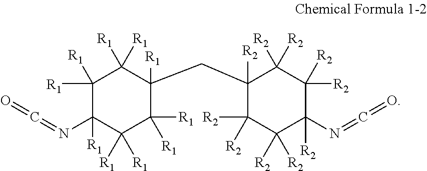

In Chemical Formula 1-2,
R₁ is the same or different, and may each independently be or include hydrogen, a halogen, or a C₁ to C₁₀ alkyl group.
R₂ is the same or different, and may each independently be or include hydrogen, a halogen, or a C₁ to C₁₀ alkyl group.

For example, the first additive may be represented by Chemical Formula 1-3 below.

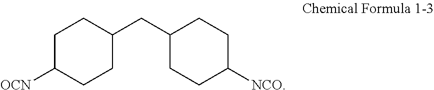

An additive according to still another example embodiment of the present disclosure may be represented by Chemical Formula 1-4 below.

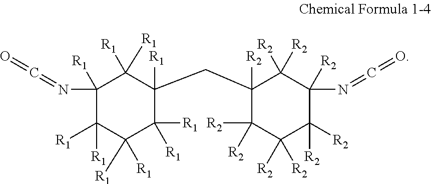

In Chemical Formula 1-4,
R₁ is the same or different, and may each independently be or include hydrogen, a halogen, or a C₁ to C₁₀ alkyl group.
R₂ is the same or different, and may each independently be or include hydrogen, a halogen, or a C₁ to C₁₀ alkyl group.

For example, the first additive may be represented by Chemical Formula 1-5 below.

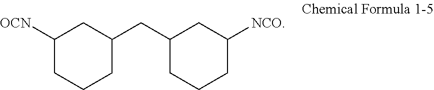

### Second Additive

A second additive according to one example embodiment of the present disclosure may be represented by Chemical Formula 2 below.

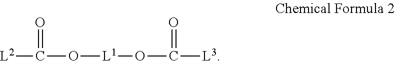

In Chemical Formula 2,
L¹ is or includes a substituted or unsubstituted C₁ to C₁₀ alkylene group, and
L² and L³ each independently is or includes a substituted or unsubstituted C₁ to C₃ alkyl group.

In one example, L¹ may be or include a substituted or unsubstituted C₁ to C₅ alkylene group, for example, a substituted or unsubstituted C₁ to C₃ alkylene group.

In one example, L¹ may be or include —CH₂—, —CH₂CH₂—, or —CH₂CH₂CH₂—.

In one example, L² and L³ may each independently be or include a substituted or unsubstituted C₁ or C₂ alkyl group.

For example, the second additive may be represented by Chemical Formula 2-1 below.

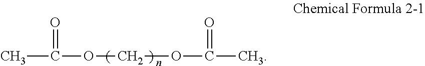

In Chemical Formula 2-1,
n is an integer in a range from 1 to 5.

In one example embodiment, the second additive may include one or more compounds represented by Chemical Formulas 2-2 to 2-7 below:

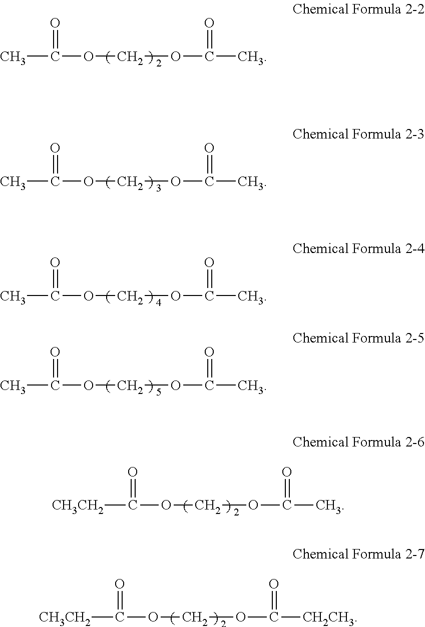

For example, the second additive may include one or more compounds represented by Chemical Formulas 2-2 to 2-4, for example, one or more compounds represented by Chemical Formulas 2-2 and 2-3, for example, a compound represented by Chemical Formula 2-2.

The additive according to one example embodiment of the present disclosure includes a mixture of the first additive and the second additive, and the weight ratio of the first additive to the second additive is in a range of about 1:10 to about 1:150.

The first additive has the effect of forming a protective film at a negative electrode interface, but exhibits a weak life cycle improvement effect at a low temperature, and may not achieve a significant capacity retention rate even with high-rate performance. An electrolyte including the first additive and the second additive in the above weight ratio may improve the lifetime of a battery over a wide temperature range including low and high temperatures as well as room temperature, and improve the high-rate performance of the battery. Among diester-based additives, the second additive may exhibit the remarkable effects of improving the lifetime and high-rate performance of a battery.

When the weight ratio is greater than about 0.1 (i.e. 1:10), due to the insufficient content of the second additive, the effects of improving the lifetime and high-rate performance of a battery may be minimal.

When the weight ratio is less than about 0.0067 (i.e. 1:150), the formation of a protective film on the surface of a negative electrode may be minimal because the second additive is included in an excessive amount and the content of the first additive is relatively insufficient.

In one example, the weight ratio may be in a range of about 1:20 to about 1:120. For example, the weight ratio may be in a range of about 1:20 to about 1:40, and within the above range, the effects of the electrolyte may be remarkable.

In one example embodiment, the electrolyte may have the effect of improving the lifetime and high-rate performance of a battery, which are described above, when applied to a battery including one or more of lithium iron phosphate (LFP), lithium manganese iron phosphate (LMFP), lithium nickel cobalt aluminum oxide (NCA), lithium nickel cobalt manganese oxide (NCM), and lithium cobalt oxide (LCO) as a positive electrode active material. For example, the positive electrode active material may be lithium nickel cobalt aluminum oxide (NCA).

In one example embodiment, the mixture may be included at about 95 wt % or more, for example, in a range of about 95 wt % to about 100 wt % or 100 wt % of the additives in the electrolyte. Within the above range, the effects of the above-described mixture may be implemented, and side effects of the electrolyte may be inhibited.

The first additive may be included at a range of about 0.1 wt % to about 2 wt % with respect to the total amount of the electrolyte. Within the above range, the effects of the above-described mixture may be implemented. For example, the first additive may be included at a range of about 0.2 wt % to about 1 wt %, or 0.2 wt % to 0.5 wt % with respect to the total weight of the electrolyte. When the content of the first additive is within the above range, the effects of the above-described mixture may be significantly increased, and the resistance of a battery may not be increased.

The second additive may be included at a range of about 5 wt % to about 40 wt % with respect to the total weight of the electrolyte. Within the above range, the effects of the above-described mixture may be implemented. For example, the second additive may be included at a range of about 5 wt % to about 20 wt %, 5 wt % to 15 wt %, or 5 wt % to 10 wt % with respect to the total amount of the electrolyte. When the content of the second additive is within the above range, the effects of the above-described mixture may be significantly increased, a fast-charging effect may be improved, and the resistance of a battery may not be further increased.

Therefore, as the electrolyte according to the present disclosure includes the mixture of the first additive and the second additive in the above weight ratio in addition to the above-described combination of a non-aqueous organic solvent and a lithium salt, a capacity retention rate can increase at low and room temperatures and in high-temperature storage, and an increase in resistance can be reduced or suppressed in a rechargeable lithium battery, and thus a rechargeable lithium battery with improved life cycle characteristics and improved high-rate performance including improved high rate capability can be realized.

Still another example embodiment of the present disclosure may include a rechargeable lithium battery, which includes a positive electrode containing a positive electrode active material, a negative electrode containing a negative electrode active material; and an electrolyte. The electrolyte includes a non-aqueous organic solvent, a lithium salt, and an additive. The additive includes a mixture of the above-described first additive and the above-described second additive, and the first additive and the second additive are included in a weight ratio in a range of about 1:10 to about 1:150.

The rechargeable lithium battery may be applicable to, e.g., automobiles, mobile phones, and/or various forms of electric devices, but the present disclosure is not limited thereto.

The positive electrode active material may include, for example, at least one of a lithium nickel-based oxide represented by Chemical Formula 3 below, a lithium cobalt-based oxide represented by Chemical Formula 4 below, a lithium iron phosphate-based compound represented by Chemical Formula 5 below, a cobalt-free lithium nickel-manganese-based oxide represented by Chemical Formula 6 below, or a combination thereof.

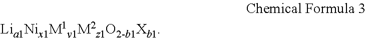

In Chemical Formula 3, 0.9≤a1≤1.8, 0.3≤x1≤1, 0≤y1≤0.7, 0≤z1≤0.7, 0.9≤x1+y1+z1≤1.1, and 0≤b1≤0.1, M₁ and M² each independently is or includes one or more of Al, B, Ba, Ca, Ce, Co, Cr, Cu, Fe, Mg, Mn, Mo, Nb, Si, Sn, Sr, Ti, V, W, and Zr, and X is or includes one or more of F, P, and S.

In Chemical Formula 3, 0.6≤x1≤1, 0≤y1≤0.4, and 0≤z1≤0.4, or 0.70≤x1≤1, 0≤y1≤0.25, and 0≤z1≤0.05.

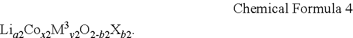

In Chemical Formula 4, 0.9≤a2≤1.8, 0.7≤x2≤1, 0≤y2≤0.3, 0.9≤x2+y2≤1.1, and 0≤b2≤0.1, M³ is or includes one or more of Al, B, Ba, Ca, Ce, Cr, Cu, Fe, Mg, Mn, Mo, Ni, Se, Si, Sn, Sr, Ti, V, W, Y, Zn, and Zr, and X is or includes one or more of F, P, and S.

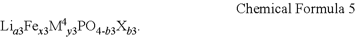

In Chemical Formula 5, 0.9≤a3≤1.8, 0.6≤x3≤1, 0≤y3≤0.4, and 0≤b3≤0.1, M⁴ is or includes one or more of Al, B, Ba, Ca, Ce, Co, Cr, Cu, Mg, Mn, Mo, Ni, Se, Si, Sn, Sr, Ti, V, W, Y, Zn, and Zr, and X is or includes one or more of F, P, and S.

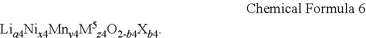

In Chemical Formula 6, 0.9≤a2≤1.8, 0.8≤x4≤1, 0≤y4≤0.2, 0≤z4≤0.2, 0.9≤x4+y4+z4≤1.1, and 0≤b4≤0.1, M⁵ is or includes one or more of Al, B, Ba, Ca, Ce, Cr, Fe, Mg, Mo, Nb, Si, Sn, Sr, Ti, V, W, and Zr, and X is or includes one or more of F, P, and S.

Particularly, the above-described electrolyte of one example embodiment may remarkably improve the deterioration in the cell performance of a battery to which the lithium nickel-based oxide represented by Chemical Formula 3 is applied.

In an example embodiment, the negative electrode active material may include at least one of graphite and a Si composite.

When the negative electrode active material includes both a Si composite and graphite, the Si composite and graphite may be included in the form of a mixture. In this case, the Si composite and graphite may be included in a weight ratio in a range of about 1:99 to about 50:50. For example, the Si composite and graphite may be included in a weight ratio in a range of about 3:97 to about 20:80, or a range of about 5:95 to about 20:80.

The Si composite includes a core including an Si-based particle, and an amorphous carbon coating layer, and for example, the Si-based particle may include one or more of a Si—C composite, SiOₓ (0<x≤2), and a Si alloy. For example, the Si—C composite may include a core including Si particles and crystalline carbon, and an amorphous carbon coating layer located on the core surface.

The crystalline carbon may include, for example, graphite, and for example, natural graphite, artificial graphite, or a mixture thereof.

When the positive electrode includes a nickel-based positive electrode active material, and the negative electrode includes a Si—C composite, the effect of improving the high-temperature stability of a rechargeable lithium battery may be improved or maximized. The rechargeable lithium battery of the above combination may operate at high voltage of about 4.2 V or more.

Hereinafter, examples and comparative examples of the present disclosure are described. However, the following examples are merely provided to illustrate the present disclosure, and the present disclosure is not limited to the following examples.

### EXAMPLES AND COMPARATIVE EXAMPLES

### (1) Preparation of Electrolyte

An electrolyte was prepared by dissolving 1.5M LiPF₆ in a non-aqueous organic solvent in which carbonate-based solvents, such as ethylene carbonate (EC), ethyl methyl carbonate (EMC), and dimethyl carbonate (DMC), were mixed in a volume ratio of 20:40:40 (based on the total of 100), adding each of a first additive and a second additive at the content (units: wt %) in Table 1 below, and mixing them together. Specifically, electrolytes according to Examples and Comparative Examples were prepared with the compositions shown in Table 1 below.

The molarity (M) of the lithium salt refers to the amount (the number of moles) of the lithium salt dissolved based on 1L of the electrolyte, the volume ratio of the non-aqueous organic solvent refers to the volume ratio of EC:EMC:DMC, and the wt % of the additives refers to the relative weight of the additives with respect to 100 wt % of the total electrolyte.

As the first additive, a compound represented by Chemical Formula 1-3 below was used.

As the second additive, a compound represented by Chemical Formula 2-2 below was used.

In Comparative Example 5, a compound of Chemical Formula 7 below was used.

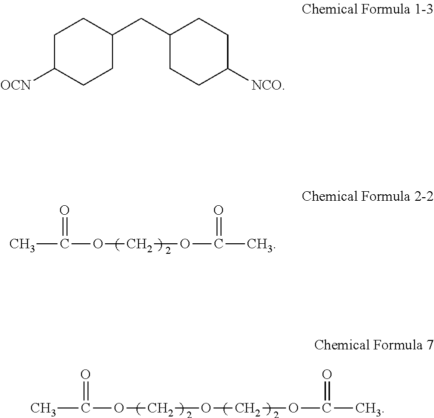

### (2) Manufacture of Rechargeable Lithium Battery

A positive electrode active material slurry was prepared by mixing 97 wt % of LiNi_{0.75}Co_{0.23}Al_{0.02}O₂ as a positive electrode active material, 0.5 wt % of graphite powder as a conductive material, 0.8 wt % of carbon black (Ketjen black), 0.2 wt % of acrylonitrile rubber, and 1.5 wt % of polyvinylidene fluoride (PVdF), inputting the resulting mixture into N-methyl-2-pyrrolidone (NMP), and stirring it for 30 minutes using a mechanical stirrer. A positive electrode was manufactured by applying the slurry to a thickness of approximately 60 m on a 20-μm-thick aluminum current collector using a doctor blade, drying the slurry in a 100° C. hot air dryer for 0.5 hours, drying the slurry again in a vacuum at 120° C. for 4 hours, and then roll-pressing the resulting product.

A negative electrode active material slurry was prepared by mixing 98 wt % of a negative electrode active material in which graphite and a Si composite were mixed in a weight ratio of 95.8:4.2, 1 wt % of styrene-butadiene rubber (SBR), and 1 wt % of carboxymethylcellulose (CMC), inputting the resulting mixture into distilled water, and stirring the resulting solution for 60 minutes using a mechanical stirrer. A negative electrode was manufactured by applying the slurry to a thickness of approximately 60 m on a 10-μm-thick copper current collector using a doctor blade, drying the slurry in a 100° C. hot air dryer for 0.5 hours, drying the slurry again in a vacuum at 120° C. for 4 hours, and then roll-pressing the resulting product.

A cylindrical rechargeable lithium battery was manufactured by forming an electrode assembly by assembling the positive electrode, the negative electrode, and a 16 μm-thick separator made of or including a polyethylene material, and injecting the electrolyte.

### EVALUATION EXAMPLES

The rechargeable lithium battery was evaluated by the following methods.

### Evaluation 1: Evaluation of Low Temperature-Charge/Discharge Cycles (Low Temperature Lifetime)

Low-temperature charge/discharge characteristics were evaluated for the rechargeable lithium batteries according to Examples and Comparative Examples. To this end, each rechargeable lithium battery was subjected to 400 low temperature cycles of charging/discharging under conditions of −10° C., and 0.33C charge (CC/CV, 4.2V, 0.025C Cut-off)/0.5C discharge (CC, 2.5V Cut-off). The capacity retention rate was calculated by the following equation.

$$Capacity retention rate ( \% ) = ( discharge capacity after 400 th cycle / discharge capacity after 1 st cycle ) \times 100.$$

### Evaluation 2: Evaluation of Room Temperature Charge/Discharge Cycles (Room Temperature Lifetime)

Room-temperature charge/discharge characteristics were evaluated for rechargeable lithium batteries according to Examples and Comparative Examples. To this end, each rechargeable lithium battery was subjected to 1,000 cycles of charging/discharging under conditions of 25° C., and 0.5C charge (CC/CV, 4.2V, 0.025C Cut-off)/0.5C discharge (CC, 2.5V Cut-off). The capacity retention rate was calculated by the following equation.

$$Capacity retention rate ( \% ) = ( discharge capacity after 1000 th cycle / discharge capacity after 1 st cycle ) \times 100.$$

Evaluation 3: Capacity Retention Rate after High-Temperature Storage (High-Temperature Storage 1)

The rechargeable lithium batteries of Examples and Comparative Examples were charged and discharged three times under the conditions of 25° C., 0.33C CC/CV charge (4.2V, 0.025C CUT-OFF) and 0.33C CC discharge (2.5V CUT-OFF) to measure the 3^{rd} discharge capacity C1. After storing each of the charged rechargeable lithium batteries at 60° C. for 60 days, the battery was additionally left at room temperature for 30 minutes and discharged at 0.33C CC (2.5V CUT-OFF) to measure a discharge capacity C2. The capacity retention rate was calculated by the following equation and shown in Table 1 below.

$$Capacity retention rate ( \% ) = C 2 / C 1 \times 100 ( \% ) .$$

Evaluation 4: DCIR Increase Rate after High-Temperature Storage (High-Temperature Storage 2)

For the rechargeable lithium batteries according to Examples and Comparative Examples, after measuring the initial direct current resistance (DCIR) as the value of ΔV/ΔI (change in voltage/change in current), the maximum energy state inside the battery was made into the fully charged state (SOC 100%). In this state, each battery was stored at 60° C. for 60 days and discharged at 0.33C to SOC 50%, and then the DC resistance was measured and the DCIR increase rate (%) was calculated by the following equation. The results are shown in Table 1 below.

$$DCIR increase rate ( \% ) = ( DCIR after 60 days / initial DCIR ) \times 100.$$

### Evaluation 5: Evaluation of High-Rate Capability

The rechargeable lithium batteries according to Examples and Comparative Examples were charged at C-rates of 0.1C, 0.2C, 0.5C, 1C, 2C, and 5C and discharged at a C-rate of 0.5C within a voltage range of 2.5V to 4.2V at 25° C. for 5 cycles each, and 5, 10, 15, 20, 25, and 30 charging and discharging cycles were performed. Referring to Evaluation 3, capacity retention rates were calculated. The capacity retention rate after the 30^{th} cycle is shown in Table 1 below.

The results of Evaluations 1 to 5 are shown in Table 1 below.

TABLE 1

| | | | | | | Low- | Room- | High- | High- | |
|---|---|---|---|---|---|---|---|---|---|---|
| | First | | Second | | | temperature | temperature | temperature | temperature | High- |
| | additive | | additive | | Weight | life | life | storage | storage | rate |
| | Type | Content | Type | Content | ratio | cycle | cycle | 1 | 2 | capability |
| Example 1 | Chemical | 0.5 | Chemical | 5 | 1:10 | 75.4 | 85.8 | 87.0 | 106.0 | 76.6 |
| | Formula | | Formula | | | | | | | |
| | 1-3 | | 2-2 | | | | | | | |
| Example 2 | Chemical | 0.5 | Chemical | 10 | 1:20 | 80.1 | 87.0 | 87.3 | 104.3 | 81.5 |
| | Formula | | Formula | | | | | | | |
| | 1-3 | | 2-2 | | | | | | | |
| Example 3 | Chemical | 0.25 | Chemical | 5 | 1:20 | 84.5 | 89.3 | 88.4 | 102.5 | 85.0 |
| | Formula | | Formula | | | | | | | |
| | 1-3 | | 2-2 | | | | | | | |
| Example 4 | Chemical | 0.25 | Chemical | 10 | 1:40 | 87.0 | 90.1 | 89.9 | 101.3 | 86.7 |
| | Formula | | Formula | | | | | | | |
| | 1-3 | | 2-2 | | | | | | | |
| Example 5 | Chemical | 0.1 | Chemical | 15 | 1:150 | 82.4 | 83.3 | 86.5 | 107.3 | 85.5 |
| | Formula | | Formula | | | | | | | |
| | 1-3 | | 2-2 | | | | | | | |
| Example 6 | Chemical | 0.1 | Chemical | 12 | 1:120 | 84.8 | 85.1 | 87.0 | 108.0 | 86.3 |
| | Formula | | Formula | | | | | | | |
| | 1-3 | | 2-2 | | | | | | | |
| Comparative | Chemical | 0.5 | — | — | — | 50.9 | 82.5 | 81.3 | 112.5 | 63.9 |
| Example 1 | Formula | | | | | | | | | |
| | 1-3 | | | | | | | | | |
| Comparative | — | — | Chemical | 5 | — | 69.1 | 81.2 | 85.5 | 108.4 | 65.7 |
| Example 2 | | | Formula | | | | | | | |
| | | | 2-2 | | | | | | | |
| Comparative | Chemical | 2 | Chemical | 10 | 1:5 | 55.0 | 78.1 | 80.5 | 110.7 | 60.7 |
| Example 3 | Formula | | Formula | | | | | | | |
| | 1-3 | | 2-2 | | | | | | | |
| Comparative | Chemical | 0.2 | Chemical | 40 | 1:200 | 44.7 | 75.6 | 73.9 | 125.1 | 66.7 |
| Example 4 | Formula | | Formula | | | | | | | |
| | 1-3 | | 2-2 | | | | | | | |
| Comparative | Chemical | 0.5 | Chemical | 10 | 1:20 | 78.1 | 86.5 | 82.9 | 118.4 | 70.3 |
| Example 5 | Formula | | Formula | | | | | | | |
| | 1-3 | | 7 | | | | | | | |

### CONCLUSION

Referring to Table 1, according to the results of Evaluations 1 to 5, it can be expected that electrolytes of the Examples can improve the high-rate performance of a battery by improving the life cycle and storage performance over a wide temperature range including low, room and high temperatures in rechargeable lithium batteries, and improving high-rate capability.

However, referring to Table 1, according to the results of Evaluations 1 to 5, Comparative Examples 1 and 2 not including one or more of the first additive and the second additive, Comparative Examples 3 and 4 outside the above weight ratio, and Comparative Example 5 satisfying the weight ratio but not including the second additive, showed minimal effects of improving lifetime and storage performance over a wide temperature range including low, room and high temperatures and also improving high-rate performance, as compared to the Examples.

Although the example embodiments of the present disclosure have been described above, the present disclosure is not limited thereto, and it is possible to implement various modifications within the scope of the claims, the detailed description of the present disclosure, and the accompanying drawings. These modifications also fall within the scope of the present disclosure.

What is claimed is:

1. An electrolyte for a rechargeable lithium battery, the electrolyte comprising:
a non-aqueous organic solvent;
a lithium salt; and
an additive;
wherein the additive comprises a mixture of a first additive represented by Chemical Formula 1 and a second additive represented by Chemical Formula 2, and
the weight ratio of the first additive to the second additive is in a range of about 1:10 to about 1:150, 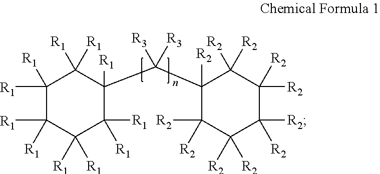
wherein:
R₁ is the same or different, each independently comprises hydrogen, a halogen, a C1 to C10 alkyl group, or an isocyanate group; and at least one R₁ comprises an isocyanate group,
R₂ is the same or different, and each comprises independently hydrogen, a halogen, a C1 to C10 alkyl group, or an isocyanate group; and at least one R₂ comprises an isocyanate group,
R₃ is the same or different, and each independently comprises hydrogen, or a cyclohexyl isocyanate residue, and
n is an integer in a range from 1 to 10, 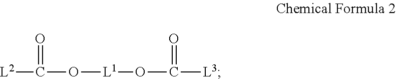
wherein:
L¹ comprises a substituted or unsubstituted C1 to C10 alkylene group, and
L² and L³ each independently comprises a substituted or unsubstituted C1 to C3 alkyl group.

2. The electrolyte of claim 1, wherein the weight ratio is a range of about 1:20 to about 1:120.

3. The electrolyte of claim 1, wherein the first additive is included at a range of about 0.1 wt % to about 2 wt % of the electrolyte.

4. The electrolyte of claim 1, wherein the second additive is included at a range of about 5 wt % to about 40 wt % of the electrolyte.

5. The electrolyte of claim 1, wherein the first additive is represented by Chemical Formula 1-2: 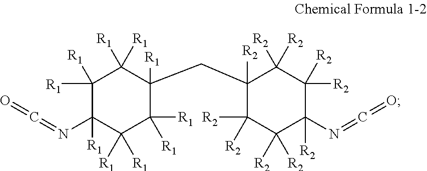
wherein:
R₁ is the same or different, each independently comprises hydrogen, a halogen, or a C1 to C10 alkyl group, and
R₂ is the same or different, and each independently comprises hydrogen, a halogen, or a C1 to C10 alkyl group.

6. The electrolyte of claim 1, wherein the first additive is represented by Chemical Formula 1-3:

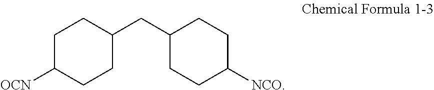

7. The electrolyte of claim 1, wherein the second additive is represented by Chemical Formula 2-1: 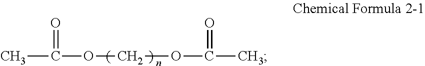
wherein n is an integer in a range from 1 to 5.

8. The electrolyte of claim 1, wherein the mixture is included at about 95 wt % or more of the additive in the electrolyte.

9. The electrolyte of claim 1, wherein the non-aqueous organic solvent is a mixture of ethylene carbonate (EC), ethyl methyl carbonate (EMC), and dimethyl carbonate (DMC) in a volume ratio of about 10 to 30:20 to 50:20 to 50.

10. The electrolyte of claim 1, wherein the lithium salt comprises one or more of LiPF₆, LiClO₄, LiBF₄, (lithium bis(fluorosulfonyl)imide (LiFSI), LiTFSI, LiSO₃CF₃, LiBOB, LiDFOB, LiDFBOP, LiTFOP, LiPO₂F₂, LiSbF₆, LiAsF₆, LiAlO₂, LiAlCl₄, LiCl, LiI, LiN(SO₃C2F₅)₂, Li(FSO₂)₂N, and LiC₄F₉SO₃.

11. The electrolyte of claim 1, wherein the concentration of the lithium salt is in a range of about 0.1 M to about 2.0M.

12. A rechargeable lithium battery, comprising:
a positive electrode including a positive electrode active material;
a negative electrode including a negative electrode active material; and
the electrolyte of claim 1.

13. The battery of claim 12, wherein the positive electrode active material comprises a lithium nickel cobalt aluminum oxide.

14. The battery of claim 12, wherein the negative electrode active material comprises at least one of graphite and a Si composite.

15. The battery of claim 12, wherein the rechargeable lithium battery is a cylindrical, prismatic, pouch-type or coin-type battery.
